(19) United States
(12) Patent Application Publication
(10) Pub. No.: US 2025/0167247 A1
(43) Pub. Date: May 22, 2025

(54) METHOD FOR MANUFACTURING LITHIUM SECONDARY BATTERY

(71) Applicants: Nissan Motor Co., Ltd., Kanagawa (JP); RENAULT S.A.S, Boulogne-Billancourt (FR)

(72) Inventors: Chihiro Honda, Kanagawa (JP); Kazuyuki Sakamoto, Kanagawa (JP); Harumi Takada, Kanagawa (JP); Ryuji Shibamura, Kanagawa (JP)

(73) Assignees: Nissan Motor Co., Ltd., Kanagawa (JP); RENAULT S.A.S, Boulogne-Billancourt (FR)

(21) Appl. No.: 19/030,144

(22) Filed: Jan. 17, 2025

Related U.S. Application Data
(63) Continuation of application No. PCT/IB2022/000415, filed on Jul. 20, 2022.

(51) Int. Cl. H01M 4/62; H01M 4/04; H01M 10/0585

(52) U.S. Cl. CPC H01M 4/628; H01M 4/045; H01M 10/0585

(57) ABSTRACT

A method for producing a lithium deposition type lithium secondary battery improving discharge capacity is provided. The lithium deposition type lithium secondary battery includes a positive electrode, a negative electrode, a solid electrolyte layer interposed between the positive electrode and the negative electrode, and a functional layer interposed between the solid electrolyte layer and the negative electrode having an electron insulating property and lithium-ion conductivity, where the functional layer is more stable than the solid electrolyte in reductive decomposition. The method includes performing a first charging step on an uncharged lithium secondary battery from uncharged state until a thickness of lithium metal deposited by the first charging step becomes 90% or more of a thickness of the functional layer, thereby forming a lithium secondary battery precursor, and performing a second charging step on the lithium secondary battery precursor.

### TECHNICAL FIELD

One or more embodiments of the present invention relate to a method for manufacturing a lithium secondary battery.

### BACKGROUND

In recent years, in order to cope with global warming, reduction of the amount of carbon dioxide is strongly desired. In the automobile industry, expectations have been focused on reduction of carbon dioxide emissions by introduction of electric vehicles (EV) and hybrid electric vehicles (HEV), and development of non-aqueous electrolyte secondary batteries such as secondary batteries for motor drive, which are key to practical application of these, has been actively conducted.

The secondary battery for motor drive is required to have extremely high output characteristics and high energy as compared with a consumer secondary battery used for a mobile phone, a notebook computer, and the like. Therefore, among all practical batteries, a lithium secondary battery having the highest theoretical energy has attracted attention, and is currently being rapidly developed.

Here, a lithium secondary battery that is currently widely used uses a combustible organic electrolyte solution as an electrolyte. In such a liquid lithium secondary battery, safety measures against liquid leakage, short circuit, overcharge, and the like are more strictly required than other batteries.

Therefore, in recent years, research and development on an all-solid state secondary battery using an oxide-based or sulfide-based solid electrolyte as an electrolyte have been actively conducted. The solid electrolyte is a material mainly composed of an ion conductor capable of ion conduction in a solid. Therefore, in the all-solid state secondary battery, in principle, various problems caused by the combustible organic electrolyte solution do not occur unlike the conventional liquid lithium secondary battery. In general, when a positive electrode material having a high potential and a large capacity and a negative electrode material having a large capacity are used, the power density and the energy density of the battery may be significantly improved.

As one type of such an all-solid state secondary battery, a so-called lithium deposition type in which lithium metal is deposited on a negative electrode current collector in a charging process is known. In the charging process of the lithium deposition type all-solid-state lithium secondary battery, lithium metal is deposited between the solid electrolyte layer and the negative electrode current collector, but it is known that a short circuit occurs due to communication between the lithium metal and the positive electrode, and the performance of the all-solid state lithium secondary battery is deteriorated. In order to address the above, for example, JP 2020-9724 A discloses a charging method of charging an all-solid-state lithium secondary battery in multiple stages, and forming a roughness coating layer of a predetermined thickness, the layer being made of lithium metal, between a solid electrolyte layer and a negative electrode current collector, thereby shortening a charging time while preventing a short circuit of the battery.

However, according to the study of the present inventors, it has been found that there is a case where a sufficient discharge capacity is not achieved when the all-solid-state lithium secondary battery after the charging process is discharged in the technology described in the above Patent Literature.

### SUMMARY

To address the above, a means capable of improving the discharge capacity in the lithium deposition type lithium secondary battery is provided.

The present inventors have conducted intensive studies in order to address the above. As a result, the present inventors have found that the above is addressed by charging a lithium secondary battery precursor provided with a predetermined functional layer between a solid electrolyte layer and a negative electrode stepwise, and have completed one or more embodiments of the present invention.

That is, one or more aspects of the present invention are a method for manufacturing a lithium secondary battery including: a positive electrode in which a positive electrode active material layer containing a positive electrode active material capable of occluding and releasing lithium ions is disposed on a surface of a positive electrode current collector; a negative electrode that has a negative electrode current collector and in which lithium metal is deposited on the negative electrode current collector during charging; a solid electrolyte layer that is interposed between the positive electrode and the negative electrode and contains a solid electrolyte; and a functional layer that is interposed between the solid electrolyte layer and the negative electrode, has an electron insulating property and lithium-ion conductivity, and is more stable than the solid electrolyte in reductive decomposition by being in contact with the lithium metal. The method for manufacturing includes: a first charging step in which the lithium metal is deposited until the thickness thereof becomes 90% or more of a thickness of the functional layer by charging a lithium secondary battery precursor having the same configuration as the configuration of the lithium secondary battery and being in an uncharged state at a first charging rate; and a second charging step of charging the lithium secondary battery precursor that has undergone the first charging step at a second charging rate. When a maximum value of the first charging rate is C₁ and a minimum value of the second charging rate is C₂, C₁<C₂ is satisfied.

### BRIEF DESCRIPTION OF THE DRAWINGS

FIG. 1 is a perspective view illustrating an appearance of a flat laminate type lithium secondary battery which is an embodiment of a lithium secondary battery manufactured by a method for manufacturing according to one or more embodiments of the present invention.

FIG. 2 is a cross-sectional view taken along line 2-2 illustrated in FIG. 1.

FIG. 3 is a perspective view of a lithium secondary battery including a pressurizing member.

FIG. 4 is a side view as viewed from direction A illustrated in FIG. 3.

### DETAILED DESCRIPTION

One or more aspects of the present invention are a method for manufacturing a lithium secondary battery including: a positive electrode in which a positive electrode active material layer containing a positive electrode active material capable of occluding and releasing lithium ions is disposed on a surface of a positive electrode current collector; a negative electrode that has a negative electrode current collector and in which lithium metal is deposited on the negative electrode current collector during charging; a solid electrolyte layer that is interposed between the positive electrode and the negative electrode and contains a solid electrolyte; and a functional layer that is interposed between the solid electrolyte layer and the negative electrode, has an electron insulating property and lithium-ion conductivity, and is more stable than the solid electrolyte in reductive decomposition by being in contact with the lithium metal, wherein the method includes a first charging step in which the lithium metal is deposited until the thickness thereof becomes 90% or more of a thickness of the functional layer by charging a lithium secondary battery precursor having the same configuration as the configuration of the lithium secondary battery and being in an uncharged state at a first charging rate; and a second charging step of charging the lithium secondary battery precursor that has undergone the first charging step at a second charging rate, in which C₁<C₂ is satisfied when a maximum value of the first charging rate is C₁ and a minimum value of the second charging rate is C₂.

According to the method for manufacturing a lithium secondary battery according to the present embodiment, the discharge capacity can be improved in a lithium deposition type lithium secondary battery.

Hereinafter, one or more embodiments of the present invention described above will be described with reference to the drawings, but the technical scope of the present invention should be determined on the basis of the description of the claims, and is not limited only to the following embodiments. Note that dimensional ratios in the drawings are exaggerated for convenience of description, and may be different from actual ratios.

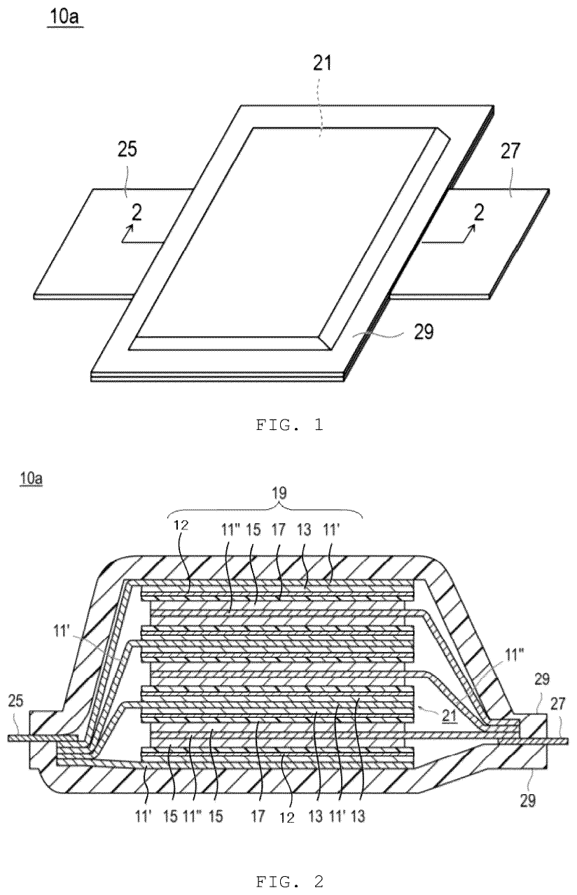

FIG. 1 is a perspective view illustrating an appearance of a flat laminate type lithium secondary battery which is one aspect of a lithium secondary battery manufactured by a method for manufacturing according to one or more embodiments of the present invention. FIG. 2 is a cross-sectional view taken along line 2-2 illustrated in FIG. 1. By adopting the laminate type, the battery can be compact and have a high capacity. In the present specification, a flat laminate type lithium secondary battery (hereinafter, also simply referred to as “laminate type battery”) that is not a bipolar type illustrated in FIGS. 1 and 2 will be described in detail as an example. However, when viewed in an electrical connection form (electrode structure) inside the lithium secondary battery according to the present embodiment, one or more embodiments of the present invention may be applied to both a non-bipolar type (internal parallel connection type) battery and a bipolar type (internal series connection type) battery.

As illustrated in FIG. 1, the laminate type battery 10a has a rectangular flat shape, and a negative electrode current collecting plate 25 and a positive electrode current collecting plate 27 for extracting electric power are drawn out from both sides thereof. A power generating element 21 is wrapped by a battery outer casing material (laminate film 29) of the laminate type battery 10a, and the periphery thereof is thermally fused, and the power generating element 21 is sealed in a state where the negative electrode current collecting plate 25 and the positive electrode current collecting plate 27 are drawn to the outside.

As illustrated in FIG. 2, the laminate type battery 10a has a structure in which a power generating element 21 of a flat and substantially rectangular shape with a charge-discharge reaction actually proceeding therein is sealed inside a laminate film 29 which is a battery outer casing material. Here, the power generating element 21 has a configuration in which a positive electrode, a solid electrolyte layer 17, a functional layer 12, and a negative electrode are laminated in this order. Note that FIG. 2 illustrates a cross section of the laminate type battery during charging, and thus the negative electrode active material layer 13 made of lithium metal exists between the negative electrode current collector 11′ and the solid electrolyte layer 17.

The positive electrode has a structure in which a positive electrode active material layer 15 containing a positive electrode active material is disposed on both surfaces of a positive electrode current collector 11″. The negative electrode has a structure in which a negative electrode active material layer 13 containing a negative electrode active material is disposed on both surfaces of a negative electrode current collector 11′. Specifically, the positive electrode, the solid electrolyte layer, and the negative electrode are laminated in this order such that one positive electrode active material layer 15 and the negative electrode active material layer 13 adjacent thereto face each other with the solid electrolyte layer 17 interposed therebetween. The functional layer 12 is disposed between the solid electrolyte layer 17 and the negative electrode. Consequently, the positive electrode, the solid electrolyte layer, the functional layer, and the negative electrode constitute one single battery layer 19. Therefore, it can be said that the laminate type battery 10a shown in FIG. 2 has a configuration in which a plurality of single battery layers 19 are laminated to be electrically connected in parallel. In addition, a confining pressure is applied to the laminate type battery 10a in the lamination direction of the power generating elements 21 by a restraint member (pressurizing member) (not illustrated). Therefore, the volume of the power generating element 21 is kept constant.

The negative electrode current collector 11′ and the positive electrode current collector 11″ have a structure in which a negative electrode current collecting plate (tab) 25 and a positive electrode current collecting plate (tab) 27 that are electrically connected to the respective electrodes (positive electrode and negative electrode) are respectively attached thereto, and the negative electrode current collecting plate 25 and the positive electrode current collecting plate 27 are led out to the outside of the laminate film 29 so as to be sandwiched between end parts of the laminate film 29 which is a battery outer casing material. The positive electrode current collecting plate 27 and the negative electrode current collecting plate 25 may be attached to the positive electrode current collector 11″ and the negative electrode current collector 11′ of each electrode by ultrasonic welding, resistance welding, or the like via a positive electrode lead and a negative electrode lead (not illustrated), respectively, as necessary.

Hereinafter, main components of the laminate type battery 10a described above will be described.

### [Positive Electrode Current Collector]

The positive electrode current collector is a conductive member configured to function as a flow path for electrons emitted from the positive electrode toward the power source with the progress of a battery reaction (charge-discharge reaction) or flowing from an external load toward the positive electrode. The material constituting the positive electrode current collector is not particularly limited. As a constituent material of the positive electrode current collector, for example, a metal or a resin having conductivity may be adopted. The thickness of the positive electrode current collector is not particularly limited, and is, for example, 10 to 100 μm.

### [Positive Electrode Active Material Layer]

A positive electrode constituting the lithium secondary battery according to the present aspect has a positive electrode active material layer containing a positive electrode active material capable of occluding and releasing lithium ions. The positive electrode active material layer 15 is disposed on the surface of the positive electrode current collector 11″ as illustrated in FIG. 2.

The positive electrode active material is not particularly limited as long as it is a material capable of releasing lithium ions in the charging process and occluding lithium ions in the discharging process of the secondary battery. An example of such a positive electrode active material includes a positive electrode active material containing M1 element and O element, the M1 element containing at least one element selected from the group consisting of Li, Mn, Ni, Co, Cr, Fe, and P. Examples of such a positive electrode active material include layered rock salt type active materials such as LiCoO₂, LiMnO₂, LiNiO₂ and Li(Ni—Mn—Co)O₂, spinel-type active materials such as LiMn₂O₄ and LiNi_{0.5}Mn_{1.5}O₄, olivine type active materials such as LifePO₄ and LiMnPO₄, Si-containing active materials such as Li₂FeSiO₄ and Li₂MnSiO₄, and the like. Examples of the oxide active material other than those described above include Li₄Ti₅O₁₂ and LiVO₂. In some cases, two or more kinds of positive electrode active materials may be used in combination. It is needless to say that a positive electrode active material other than the above may be used. In one or more embodiments, the positive electrode active material layer 15 constituting the lithium secondary battery according to the present aspect may contain a layered rock salt type active material (for example, Li (Ni—Mn—Co)O₂) containing lithium and cobalt as a positive electrode active material from the viewpoint of output characteristics.

The content of the positive electrode active material in the positive electrode active material layer is not particularly limited, but for example, may be within a range of 30 to 99% by mass, within a range of 40 to 90% by mass, or within a range of 45 to 80% by mass.

In the lithium secondary battery according to the present aspect, the positive electrode active material layer may further contain a solid electrolyte. Examples of the solid electrolyte include a sulfide solid electrolyte, a resin solid electrolyte, and an oxide solid electrolyte. Note that as the solid electrolyte, a material having a desired volume elastic modulus may be appropriately selected according to the degree of volume expansion accompanying charge and discharge of the electrode active material to be used.

In another embodiment of the secondary battery according to the present aspect, from the viewpoint of exhibiting excellent lithium-ion conductivity and being capable of better following the volume change of the electrode active material accompanying charge and discharge, the solid electrolyte may be a sulfide solid electrolyte containing a S element, a sulfide solid electrolyte containing a Li element, an M element, and a S element, the M element being a sulfide solid electrolyte containing at least one element selected from the group consisting of P, Si, Ge, Sn, Ti, Zr, Nb, Al, Sb, Br, Cl, and I, or a sulfide solid electrolyte containing a S element, a Li element, and a P element. The sulfide solid electrolyte may have a Li₃PS₄ skeleton, a Li₄P₂S₇ skeleton, or a Li₄P₂S₆ skeleton. Examples of the sulfide solid electrolyte having a Li₃PS₄ skeleton include LiI—Li₃PS₄, LiI—LiBr—Li₃PS₄, and Li₃PS₄. In addition, examples of the sulfide solid electrolyte having a Li₄P₂S₇ skeleton include a Li—P—S-based solid electrolyte called LPS. As the sulfide solid electrolyte, for example, LGPS represented by Li₍₄₋ₓ₎Ge₍₁₋ₓ₎PₓS₄ (x satisfies 0<x<1) or the like may be used. More specifically, examples thereof include LPS(Li₂S—P₂S₅), Li₇P₃S₁₁, Li_{3.2}P_{0.96}S, Li_{3.25}Ge_{0.25}P_{0.75}S₄, Li₁₀GeP₂S₁₂, Li₆PS₅X (wherein X is Cl, Br or I), or the like. Note that the description of “Li₂S—P₂S₅” means a sulfide solid electrolyte obtained using a raw material composition containing Li₂S and P₂S₅, and the same applies to other descriptions. Among them, from the viewpoint of having a high ion conductivity and a low volume elastic modulus and thus being capable of better following the volume change of the electrode active material accompanying charge and discharge, the sulfide solid electrolyte may be selected from the group consisting of LPS (Li₂S—P₂S₅), Li₆PS₅X (wherein X is Cl, Br, or I), Li₇P₃S₁₁, Li_{3.2}P_{0.96}S, and Li₃PS₄.

The content of solid electrolyte in the positive electrode active material layer is not particularly limited, but for example, may be within a range of 1 to 70% by mass, within a range of 10 to 60% by mass, or within a range of 15 to 55% by mass.

The positive electrode active material layer may further contain at least one of a conductive aid and a binder in addition to the positive electrode active material and the solid electrolyte. The thickness of the positive electrode active material layer varies depending on the configuration of a lithium secondary battery as a target, but may be, for example, in the range of 0.1 to 1000 μm, or 40 to 150 μm.

### [Solid Electrolyte Layer]

The solid electrolyte layer is a layer interposed between the positive electrode and the negative electrode, and contains a solid electrolyte (usually as a main component). More specifically, the solid electrolyte layer is a layer interposed between the positive electrode active material layer and the functional layer. Since the specific form of the solid electrolyte contained in the solid electrolyte layer is the same as that described above, the detailed description thereof is omitted here.

The content of the solid electrolyte in the solid electrolyte layer may be, for example, within a range of 10 to 100% by mass, within a range of 50 to 100% by mass, or within a range of 90 to 100% by mass with respect to the total mass of the solid electrolyte layer. The solid electrolyte layer may further contain a binder in addition to the solid electrolyte described above. The thickness of the solid electrolyte layer varies depending on the configuration of a lithium secondary battery as a target, but may be, for example, in the range of 0.1 to 1000 μm, or 10 to 40 μm.

### [Negative Electrode Current Collector]

The negative electrode current collector is a conductive member configured to function as a flow path for electrons emitted from the negative electrode toward the external load with the progress of a battery reaction (charge-discharge reaction) or flowing from a power source toward the negative electrode. The material constituting the negative electrode current collector is not particularly limited. As a constituent material of the negative electrode current collector, for example, a metal or a resin having conductivity may be adopted. The thickness of the negative electrode current collector is not particularly limited, and is, for example, 10 to 100 μm.

### [Negative Electrode Active Material Layer]

The lithium secondary battery according to the present aspect is a so-called lithium deposition type in which lithium metal is deposited on a negative electrode current collector in a charging process. A layer made of lithium metal deposited on the negative electrode current collector in this charging process is the negative electrode active material layer of the lithium secondary battery according to the present aspect. Therefore, the thickness of the negative electrode active material layer increases with the progress of the charging process, and the thickness of the negative electrode active material layer decreases with the progress of the discharging process. There may be no negative electrode active material layer during complete discharge, but in some cases, a negative electrode active material layer made of a certain amount of lithium metal may be disposed during complete discharge.

### [Functional Layer]

In the lithium secondary battery according to the present aspect, a functional layer is provided between the solid electrolyte layer and the negative electrode. This functional layer is a layer having an electron insulating property and lithium-ion conductivity. In addition, the functional layer is required to be more stable than the solid electrolyte in reductive decomposition due to being in contact with lithium metal.

Here, “more stable than solid electrolyte in reductive decomposition due to being in contact with lithium metal” means that when a tendency that the solid electrolyte constituting the solid electrolyte layer undergoes reductive decomposition due to being in contact with lithium metal is compared with a tendency that the constituent material of the functional layer undergoes reductive decomposition due to being in contact with lithium metal, the latter tendency is smaller. Note that whether or not the constituent material of the functional layer satisfies this condition may be determined by whether or not the current flowing through the functional layer is smaller than the current flowing through the solid electrolyte layer when the voltage is swept around 0 V [vs. Li/Li+] by a cyclic voltammetry method using each of the solid electrolyte layer and the functional layer as the working electrode and using lithium metal as the counter electrode.

By such a functional layer being interposed between the solid electrolyte layer and the negative electrode, lithium metal deposited on the surface of the negative electrode current collector during charging is not in contact with the solid electrolyte layer, and deterioration of the solid electrolyte layer due to reductive decomposition is suppressed. In addition, by disposing the functional layer at the position, it is also possible to prevent dendrite from growing from the lithium metal side when a crack occurs in the solid electrolyte layer. Here, whether or not the functional layer of the lithium secondary battery according to the present aspect is disposed can be determined, for example, by confirming whether or not a layer corresponding to the functional layer exists on the main surface of the solid electrolyte layer by SEM-EDX observation of a cross section of the lithium secondary battery, and then analyzing the composition by elemental analysis or the like. In addition, when it is difficult to make a determination by the above method for the reason that the functional layer is thin or the like, it is possible to make a determination by analyzing a layer corresponding to the functional layer while performing etching by the XPS method.

Note that the constituent material of the functional layer as described above is not particularly limited, and may be suitably used as long as it is a material that satisfies the conditions described above. For example, the functional layer may contain one or two or more kinds of materials selected from the group consisting of lithium oxide (Li₂O), lithium halide (Lithium fluoride (LiF), lithium chloride (LiCl), lithium bromide (LiBr), lithium iodide (LiI)), a lithium-ion conductive polymer, a composite metal oxide represented by Li-M-O (M is one or two or more kinds of metal elements selected from the group consisting of Mg, Au, Al, Sn, and Zn), and a Li—Ba—TiO₃ composite oxide. All of these materials are particularly stable in reductive decomposition by being in contact with lithium metal, and thus are suitable as constituent materials of the functional layer. Among them, the functional layer may contain one or more kinds selected from the group consisting of lithium oxide (Li₂O), lithium chloride (LiCl), lithium fluoride (LiF), lithium bromide (LiBr), and lithium iodide (LiI) because the rate characteristics of the battery may be improved. This is considered to be because the activation barrier when lithium ions diffuse through the solid electrolyte layer and the functional layer during charge and discharge is lowered, so that the interface diffusion rate of lithium ions is improved, and the contact area between the functional layer and the negative electrode active material layer (lithium metal layer) is sufficiently secured.

The average thickness of the functional layer is not particularly limited, and the functional layer only needs to be disposed at a thickness capable of exhibiting the function described above. However, from the viewpoint of suppressing an increase in internal resistance, the average thickness of the functional layer may be smaller than the average thickness of the solid electrolyte layer. In addition, from the viewpoint of sufficiently exhibiting the protective effect by providing the functional layer, the average thickness of the functional layer may be a predetermined value or more. From these viewpoints, the average thickness of the functional layer may be 0.1 nm to 30 μm, 0.5 nm to 25 μm, 0.5 nm to 20 μm, 10 nm to 1000 nm, or 100 nm to 500 nm. Note that the “average thickness” of the functional layer means a value calculated as an arithmetic average value of thicknesses obtained by cutting the functional layer constituting the lithium secondary battery along the lamination direction, observing a cross section of the functional layer with a scanning electron microscope (SEM), and measuring thicknesses of several to several tens of different portions, respectively.

### [Positive Electrode Current Collecting Plate and Negative Electrode Current Collecting Plate]

A material constituting the current collecting plate is not particularly limited, and a known highly conductive material conventionally used as a current collecting plate for a secondary battery may be used. As a constituent material of the current collecting plate, for example, a metal material such as aluminum, copper, titanium, nickel, stainless steel (SUS), or an alloy thereof may be preferable. From the viewpoint of lightweight, corrosion resistance, and high conductivity, aluminum and copper may be preferable, and aluminum may be preferable. Note that the positive electrode current collecting plate and the negative electrode current collecting plate may be made of the same material or different materials.

### [Positive Electrode Lead and Negative Electrode Lead]

The current collector and the current collecting plate may be electrically connected via a positive electrode lead or a negative electrode lead. As a constituent material of the positive electrode and the negative electrode lead, a material used in a known lithium secondary battery may be similarly adopted. Note that a portion taken out from the exterior may be covered with a heat resistant and insulating heat shrinkable tube or the like so as not to affect a product (for example, automotive components, in particular, electronic devices, and the like) through electric leakage caused by being in contact with peripheral equipment, wiring, or the like.

### [Battery Outer Casing Material]

As the battery outer casing material, a known metal case can be used, and a bag-shaped case using a laminate film containing aluminum, the case being able to cover a power generating element, may be used. As the laminate film, for example, a laminate film having a three-layer structure formed by laminating PP, aluminum, and nylon in this order, or the like may be used, but the laminate film is not limited thereto. A laminate film is desirable from the viewpoint of high output and excellent cooling performance, and being suitably usable for batteries for large devices for EV and HEV. In addition, since it is possible to easily adjust the group pressure applied to the power generating element from the outside, an outer case may be a laminate film containing aluminum.

### [Method for Manufacturing Lithium Secondary Battery]

### (Production of Lithium Secondary Battery Precursor)

The lithium secondary battery manufactured by the method for manufacturing according to the present aspect has undergone a charging step. Here, in the present specification, a structure to be subjected to the charging step is referred to as a “lithium secondary battery precursor”. The “lithium secondary battery precursor” has the same configuration as the lithium secondary battery manufactured by the method for manufacturing according to the present aspect (specifically, it essentially includes the positive electrode current collector, the positive electrode active material layer, the solid electrolyte layer, the functional layer, and the negative electrode current collector described above.). It can also be said that the “lithium secondary battery precursor” is in a state in which the charging step described below has not been performed.

A method for producing the lithium secondary battery precursor is not particularly limited, but for example, the lithium secondary battery precursor may be prepared according to the following method. First, a powder composition (positive electrode mixture) containing a positive electrode active material and, if necessary, a solid electrolyte, a binder, and a conductive aid is prepared. Next, the powder composition is subjected to a rolling treatment by a roll press machine to produce a positive electrode active material layer, and the positive electrode active material layer and the positive electrode current collector are stacked and subjected to pressing treatment, to produce a positive electrode. Subsequently, the solid electrolyte is mixed with a solvent to prepare a solid electrolyte slurry, and the solid electrolyte slurry is applied to the surface of the support and dried to produce a solid electrolyte layer as a free-standing film. Thereafter, a functional layer is formed on one surface of the obtained solid electrolyte layer by a technique such as sputtering. On the positive electrode active material layer side of the obtained positive electrode, a solid electrolyte layer on which the functional layer similarly obtained above is formed is superimposed such that the exposed surface of the solid electrolyte layer faces the positive electrode active material layer, and pressed. Subsequently, a lithium secondary battery precursor may be produced by laminating the negative electrode current collector on the exposed surface of the functional layer.

### (Charging Step)

The method for manufacturing a lithium secondary battery according to the present aspect is characterized by performing a first charging step and a second charging step on a lithium secondary battery precursor having the above-described configuration. The first charging step is a step in which lithium metal is deposited until the thickness thereof becomes 90% or more of the thickness of the functional layer by charging at the first charging rate. The second charging step is a step of charging the lithium secondary battery precursor that has undergone the first charging step at the second charging rate. Then, these first and second charging rates are determined so that when a maximum value of the first charging rate is C₁ and a minimum value of the second charging rate is C₂, C₁<C₂ is satisfied. The method for manufacturing a lithium secondary battery according to one or more embodiments of the present invention is capable of improving the discharge capacity in a lithium secondary battery by having these two charging steps. Although the mechanism by which such an effect is exhibited is not completely clear, the following is estimated. First, as charging progresses, lithium metal is deposited from the functional layer toward the negative electrode current collector. That is, the layer of lithium metal (hereinafter, the first lithium metal layer) deposited in the first charging step is located closer to the functional layer side than the layer of lithium metal (hereinafter, the second lithium metal layer) deposited in the second charging step.

Here, by performing charging using the first charging rate which is a relatively low current value in the first charging step, the first lithium metal layer having a uniform thickness is deposited. Then, in the first charging step, lithium metal is deposited until the thickness of the first lithium metal layer having a uniform thickness becomes 90% or more of the thickness of the functional layer. Thereafter, in the second charging step, charging is performed using the second charging rate which is a relatively high current value. At this time, since the first lithium metal layer having a uniform thickness exists on the surface on the functional layer side, when the thickness of the lithium metal layer increases and the functional layer is compressed, a large pressure is not locally applied to the functional layer. As a result, cracking of the functional layer may be prevented. As described above, the first lithium metal layer has a thickness of 90% or more of the thickness of the functional layer. Therefore, even when the thickness of the second lithium metal layer increases in the second charging step and pressure is applied to other layers, the first lithium metal layer protects the functional layer from the pressure. As a result, cracking of the functional layer may be prevented as expected. By preventing cracking of the functional layer as described above, it is possible to prevent reductive decomposition of the solid electrolyte layer due to contact between the lithium metal and the solid electrolyte layer. Furthermore, by preventing cracking of the functional layer, a short circuit caused by dendrite generated from the lithium metal side may also be prevented.

### (First Charging Step)

The first charging step is a step in which lithium metal is deposited until the thickness thereof becomes 90% or more of the thickness of the functional layer by charging the lithium secondary battery precursor having the above-described configuration at the first charging rate. In the present specification, the thickness of lithium metal is calculated by the following method. First, the negative electrode active material layer that is a layer in which lithium is deposited is cut along the lamination direction of the batteries. Subsequently, the cross section of the negative electrode active material layer is observed with a scanning electron microscope (SEM), and the thicknesses of several to several tens of different portions are measured. Then, an average value of these thicknesses is calculated and taken as the thickness of the lithium metal.

The thickness of the lithium metal deposited in the first charging step is 90% or more of the thickness of the functional layer, but may be 92% or more and 120% or less, 94% or more and 110% or less, or substantially the same as the thickness of the functional layer. Here, being substantially the same means that the thickness of the lithium metal is 95% or more and 105% or less with respect to the thickness of the functional layer. Since the thickness of the lithium metal is substantially the same as the thickness of the functional layer, it is possible to shorten the charge time while improving the discharge capacity by preventing cracking of the functional layer, and thus improving the production efficiency. Furthermore, the thickness of the lithium metal deposited in the first charging step may be 97% or more and 103% or less of the thickness of the functional layer, 99% or more and 101% or less, or 100%.

The first charging rate in the first charging step is not particularly limited as long as a maximum value C₁ of the first charging rate is smaller than the minimum value C₂ of the second charging rate in the second charging step. In addition, the first charging rate in the first charging step may be constant or may change. From the viewpoint of shortening the charging time in the manufacturing step, the first charging rate in the first charging step may be constant (that is, the first charging rate remains constant at C₁). Furthermore, the maximum value C₁ of the first charging rate may be 0.03 [C] or less, or 0.01 [C] or less. When the maximum value C₁ of the first charging rate is within the above range, lithium metal is deposited in a more uniform state. Furthermore, the lower limit value of the maximum value C₁ of the first charging rate is not particularly limited, but may be 0.0001 [C] or more, or 0.0005 [C] or more. When the lower limit value of the maximum value C₁ of the first charging rate is within the above-described range, the charging time in the first charging step may be made suitable for manufacturing the lithium secondary battery. Note that 1 [C] is a current value at which the battery is completely charged from the completely discharged state or is completely discharged from the completely charged state for one hour at the current value. That is, the maximum value C₁ of the first charging rate may be 0.0001 [C] or more and 0.03 [C] or less, or 0.0005 [C] or more and 0.01 [C] or less.

### (Second Charging Step)

The second charging step is a step of charging the lithium secondary battery precursor that has undergone the first charging step at the second charging rate that is larger than the first charging rate.

The second charging rate in the second charging step is not particularly limited as long as the minimum value C₂ is larger than the maximum value C₁ of the first charging rate in the first charging step. In addition, the second charging rate in the second charging step may be constant or may change. From the viewpoint of shortening the charging time in the manufacturing step, the second charging rate in the second charging step may be constant (that is, the second charging rate remains constant at C₂). Furthermore, the minimum value C₂ of the second charging rate may be more than 0.03 [C], or 0.04 [C] or more. Furthermore, the upper limit value of the minimum value C₂ of the second charging rate is not particularly limited, but may be 0.5 [C] or less, or 0.1 [C] or less. When the minimum value C₂ of the second charging rate is in the above-described range, it is possible to cause lithium metal to be deposited in a more uniform state while maintaining a sufficient charging speed. That is, the minimum value C₂ of the second charging rate may be more than 0.03 [C] and 0.5 [C] or less, or 0.04 [C] or more and 0.1 [C] or less.

### (Other Charging Steps)

The method for manufacturing a lithium secondary battery according to one or more aspects of the present invention may have another charging step in addition to the first charging step and the second charging step. For example, the charging step A may be included between the first charging step and the second charging step, and the charging step B may be included after the second charging step.

In the charging step A, a charging rate smaller than the first charging rate may be used, a charging rate larger than the first charging rate and smaller than the second charging rate may be used, or a charging rate larger than the second charging rate may be used. However, from the viewpoint of uniformity of lithium metal deposition and manufacturing efficiency of the lithium secondary battery, it may be preferable to use a charging rate that is equal to or larger than the first charging rate and equal to or smaller than the second charging rate. In the charging step B, a charging rate smaller than the first charging rate may be used, a charging rate equal to or larger than the first charging rate and equal to or smaller than the second charging rate may be used, or a charging rate larger than the second charging rate may be used. However, from the viewpoint of manufacturing efficiency of the lithium secondary battery, it may be preferable to use a charging rate which is equal to or larger than the first charging rate and equal to or smaller than the second charging rate, or a charging rate larger than the second charging rate.

However, from the viewpoint that lithium metal is deposited in a more uniform state and further that a sufficient charging speed is achieved in the manufacture of the lithium secondary battery, the charging step may consist of two steps of a first charging step and a second charging step. In other words, charging may be started in the first charging step, and the first charging step may be ended at a point of time when the lithium metal is deposited until the thickness thereof becomes 90% or more of the thickness of the functional layer, and then the second charging step may be started, and the second charging step may be ended at a point of time when the functional layer is fully charged. Note that a charge pause time (interval) may be provided between the charging steps. The initial charging step performed on the lithium secondary battery precursor having the same configuration as that of the lithium secondary battery and being in an uncharged state may consist only of a first charging step in which lithium metal is deposited until the thickness thereof becomes the same thickness of the functional layer by charging at the first charging rate and a second charging step of charging the lithium secondary battery precursor that has undergone the first charging step (that is, a state in which the lithium metal of the same thickness as the thickness of the functional layer is deposited) at the second charging rate, and the first charging rate in the first charging step may be constant and the second charging rate in the second charging step may be constant.

### (Discharging Step)

The method for manufacturing a lithium secondary battery according to an embodiment may further include a discharging step of discharging the lithium secondary battery that has undergone the second charging step. In the discharging step, it may be preferable to perform discharging so that the thickness of the lithium metal after discharging is not thinner than the thickness of the lithium metal deposited in the first charging step. By performing the discharge in this range, it is possible to maintain the uniformity of the lithium metal deposition at the time of charging again, to prevent cracking of the functional layer, and to prevent the growth of dendrite and the reductive decomposition of the solid electrolyte layer.

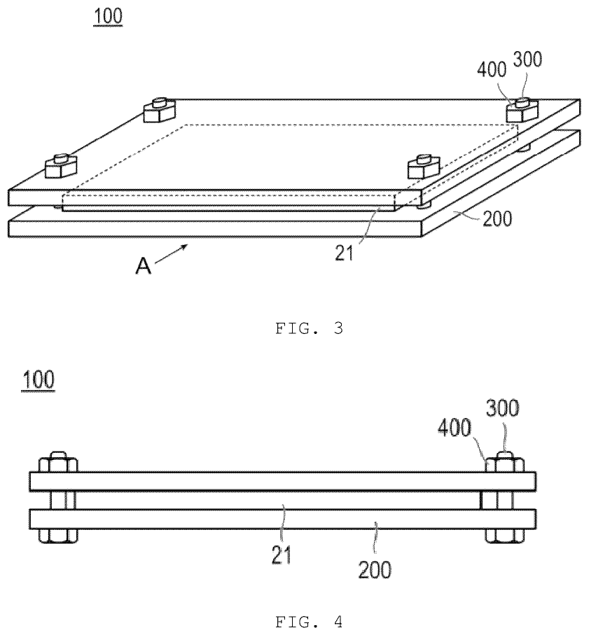

Each of the charging step and the discharging step described above may be performed while a confining pressure is applied to the cell in the lamination direction using a pressurizing member. By performing charge and discharge while performing pressurizing, the thickness of lithium metal deposited becomes more uniform. FIGS. 3 and 4 illustrate an example of a power generating element including a pressurizing member. The power generating element 100 including the pressurizing member includes a power generating element 21 sealed in the laminate film 29 illustrated in FIG. 1, two metal plates 200 sandwiching the power generating element 21 sealed in the laminate film 29, and a bolt 300 and a nut 400 as fastening members. The fastening members (the bolt 300 and the nut 400) have a function of fixing the power generating element 21 sealed by the laminate film 29 in a state where the metal plate 200 sandwiches the power generating element 21. Consequently, the metal plate 200 and the fastening members (the bolt 300 and the nut 400) function as pressurizing members configured to pressurize (restrain) the power generating element 21 in the lamination direction thereof. Note that the pressurizing member is not particularly limited as long as the pressurizing member is capable of pressurizing the power generating element 21 in the lamination direction thereof. Typically, a combination of a plate formed of a material having rigidity such as the metal plate 200 and the above-described fastening member is used as the pressurizing member. As the fastening member, not only the bolt 300 and the nut 400 but also a tension plate that fixes the end part of the metal plate 200 so as to restrain the power generating element 21 in the lamination direction thereof, or the like may be used.

The lower limit of the load applied to the power generating element 21 (confining pressure in the lamination direction of the power generating elements) may be, for example, 0.05 MPa or more, 0.1 MPa or more, 0.5 MPa or more, or 1 MPa or more. The upper limit of the confining pressure in the lamination direction of the power generating elements may be, for example, 10 MPa or less, 7 MPa or less, 5 MPa or less, or 4 MPa or less. That is, the confining pressure in the lamination direction of the power generating element may be, for example, 0.05 MPa to 10 MPa, 0.1 MPa to 7 MPa, 0.5 MPa to 5 MPa, or 1 MPa to 4 MPa. When the confining pressure in the lamination direction of the power generating element is in the above range, the deposition of lithium becomes more sufficiently uniform, and further, it is possible to prevent cracking of each layer (particularly, cracking of the functional layer) due to the confining pressure.

### (Discharge Method)

One or more aspects of the present invention are a method for discharging a lithium secondary battery according to one or more aspects of the present invention described above. The discharging method is a method in which discharging is performed such that the thickness of the lithium metal after discharging is not thinner than the thickness of the lithium metal deposited in the first charging step. By performing the discharge in the method, it is possible to maintain the uniformity of the lithium metal deposition at the time of charging again, to prevent cracking of the functional layer, and to prevent the growth of dendrite and the reductive decomposition of the solid electrolyte layer.

Although one or more embodiments of the present invention have been described above, the present invention is not limited to only the configuration described in the embodiment described above, and may be appropriately changed on the basis of the description of the claims. Note that the following embodiments are also included in the scope of the present invention: the method for manufacturing a lithium secondary battery according to claim 1, the method having the feature of claim 2; the method for manufacturing a lithium secondary battery according to claim 1 or 2, the method having the feature of claim 3; the method for manufacturing a lithium secondary battery according to any one of claims 1 to 3, the method having the feature of claim 4; the method for manufacturing a lithium secondary battery according to any one of claims 1 to 4, the method having the feature of claim 5; the method for manufacturing a lithium secondary battery according to any one of claims 1 to 5, the method having the feature of claim 6; the method for manufacturing a lithium secondary battery according to any one of claims 1 to 6, the method having the feature of claim 7; the method for manufacturing a lithium secondary battery according to any one of claims 1 to 7, the method having the feature of claim 8; the method for manufacturing a lithium secondary battery according to any one of claims 1 to 8, the method having the feature of claim 9; the method for manufacturing a lithium secondary battery according to any one of claims 1 to 9, the method having the feature of claim 10.

### EXAMPLES

Hereinafter, one or more embodiments of the present invention will be described in more detail with reference to Examples. However, the technical scope of the present invention is not limited only to the following examples. In the following description, the instruments, devices, and the like used in the glove box were sufficiently dried in advance.

### Production Example of Evaluation Cell

### Production of Evaluation Cell of Example 1

### (Production of Positive Electrode)

NMC composite oxide (LiNi_{0.8}Mn_{0.1}Co_{0.1}O₂) as a positive electrode active material, a sulfide solid electrolyte having lithium-ion conductivity (LPS (Li₂S—P₂S₅)), acetylene black as a conductive aid, and styrene-butadiene rubber (SBR) as a binder were prepared. In a glove box in an argon atmosphere with a dew point of −68° C. or lower, the NMC composite oxide, the solid electrolyte, the binder, and the conductive aid were weighed so as to have a mass ratio of 78.8:15.3:2.9:3.0, mixed in an agate mortar, and then further mixed and stirred in a planetary ball mill to obtain a powder composition (positive electrode mixture).

Subsequently, the powder composition (positive electrode mixture) obtained above was supplied to a powder inlet set in a roll press machine. Then, the powder composition was subjected to a rolling treatment using a roll press machine (conditions are indicated below) to form the powder composition into a sheet shape. Subsequently, a rolling treatment of folding the powder composition that is the sheet shape into two to compress using a roll press machine was repeated until the thickness of the sheet reached 100 μm to produce a positive electrode active material layer.

### (Conditions of Roll Pressing Machine)

Roll size: 250 mm×400 mm
Roll rotation speed: 1 m/min
Pressure: 10 kN (linear pressure: 25 KN/m).

Subsequently, the positive electrode active material layer and an aluminum foil (thickness: 12 μm) as a positive electrode current collector were stacked and pressed to produce a positive electrode.

To 100 parts by mass of a sulfide solid electrolyte (LPS (Li₂S—P₂S₅)), 2 parts by mass of styrene-butadiene rubber (SBR) was added, and mesitylene as a solvent was added to prepare a solid electrolyte slurry. Then, the solid electrolyte slurry prepared above was coated on the surface of the stainless steel foil as a support and dried to obtain a solid electrolyte layer (thickness: 30 μm) as a free-standing film. Thereafter, a functional layer (thickness: 250 nm) made of lithium chloride (LiCl) was formed on the entire one surface of the obtained solid electrolyte layer by sputtering.

### (Assembly of Evaluation Cell Precursor)

On the positive electrode active material layer side of the positive electrode produced above, a solid electrolyte layer on which the functional layer similarly produced above was transferred by cold isostatic pressing (CIP) such that the exposed surface of the solid electrolyte layer faces the positive electrode active material layer. Finally, a stainless steel foil (thickness: 10 μm) as a negative electrode current collector was laminated on the exposed surface of the functional layer to assemble an evaluation cell (lithium deposition type lithium secondary battery) precursor.

### (Charging of Evaluation Cell Precursor)

A positive electrode lead and a negative electrode lead were connected to each of the positive electrode current collector and the negative electrode current collector of the evaluation cell precursor of Example 1 produced above, and charging was performed in the first charging step and the second charging step. First, in the first charging step, the first charging rate was set to 0.01 C, and charging was performed until the thickness of lithium metal deposited on the negative electrode current collector reached 250 nm. The thickness of lithium metal was calculated as an arithmetic average value of thicknesses obtained by cutting the lithium secondary battery precursor that has undergone the first charging step along the lamination direction, observing a cross section of the negative electrode active material layer, which is a layer in which lithium was deposited, with a scanning electron microscope (SEM), and measuring the thicknesses at 10 different points, respectively.

Subsequently, the lithium secondary battery precursor that has undergone the first charging step was charged in the second charging step at a second charging rate of 0.05 C and an upper limit voltage of 4.3 V until a fully charged (100% charged) state is reached, whereby an evaluation cell of Example 1 was obtained. Note that in the first charging step and the second charging step, charging was performed while a confining pressure of 3 [MPa] was applied in the lamination direction of the evaluation cells using the pressurizing member.

### [Production of Evaluation Cell of Example 2]

An evaluation cell of Example 2 was produced in the same manner as in Example 1 except that the confining pressure was not applied in the first charging step and the second charging step.

### [Production of Evaluation Cell of Example 3]

An evaluation cell of Example 3 was produced in the same manner as in Example 1 except that the applied confining pressure is 0.1 MPa in the first charging step and the second charging step.

### [Evaluation Cell of Example 4]

An evaluation cell of Example 4 was produced in the same manner as in Example 1 except that the thickness of the functional layer was set to 5000 nm and charging was performed until the thickness of lithium metal deposited on the negative electrode current collector in the first charging step reached 5000 nm.

### [Evaluation Cell of Example 5]

An evaluation cell of Example 5 was produced in the same manner as in Example 1 except that the thickness of the lithium metal deposited on the negative electrode current collector in the first charging step was set to 500 nm.

### [Evaluation Cell of Example 6]

An evaluation cell of Example 6 was produced in the same manner as in Example 1 except that lithium fluoride (LiF) was used as the functional layer.

### [Evaluation Cell of Example 7]

An evaluation cell of Example 7 was produced in the same manner as in Example 1 except that the first charging rate was set to 0.03 C in the first charging step.

### [Evaluation Cell of Example 8]

An evaluation cell of Example 8 was produced in the same manner as in Example 1 except that the thickness of the functional layer was set to 0.3 nm and the thickness of lithium metal deposited on the negative electrode current collector in the first charging step was set to 0.3 nm, using the lithium oxide (Li₂O) as the functional layer.

### [Evaluation Cell of Example 9]

An evaluation cell of Example 9 was produced in the same manner as in Example 1 except that the thickness of the functional layer was set to 25000 nm and the thickness of lithium metal deposited on the negative electrode current collector in the first charging step was set to 25000 nm.

### [Evaluation Cell of Comparative Example 1]

An evaluation cell of Comparative Example 1 was produced in the same manner as in Example 1 except that the thickness of the lithium metal deposited on the negative electrode current collector in the first charging step was set to 125 nm.

### [Evaluation Cell of Comparative Example 2]

An evaluation cell of Comparative Example 2 was produced in the same manner as in Example 1 except that the first charging step was not performed and charging was performed only in the second charging step.

### [Evaluation Cell of Comparative Example 3]

An evaluation cell of Comparative Example 3 was produced in the same manner as in Example 1 except that the functional layer was not provided.

### <Evaluation of Discharge Capacity>

The discharge capacity was evaluated by performing the following discharging step for the evaluation cell produced in each of the above Examples and Comparative Examples. The measurement was performed in a constant temperature thermostatic bath set at 25° C. using a charge-discharge test apparatus (HJ-SD8 manufactured by HOKUTO DENKO CORPORATION).

In the discharging step, constant current (CC) discharge was performed at a current value corresponding to 0.05 C assuming that a lower limit voltage was 2.5 V. Then, the capacity (discharge capacity) was measured during discharge treatment, normalized by the mass of the positive electrode active material used in each evaluation cell, and the discharge capacity per mass of the active material was calculated. In addition, for the discharge capacity per mass of the active material calculated in this manner, the percentage (discharge capacity retention rate (%)) to the theoretical discharge capacity was calculated and used as an evaluation index of the discharge capacity. The results are listed in Table 1 below. Note that in the discharging step, charging was performed while a confining pressure was applied in the lamination direction of the evaluation cells using the pressurizing member. The applied pressure was 3 MPa in Examples 1 and 4 to 9 and Comparative Examples 1 to 3, and 0.1 MPa in Example 3. In Example 2, no pressure was applied.

TABLE 1

| | | | | | Li | | |
|---|---|---|---|---|---|---|---|
| | | | | | deposition | | |
| | | | | | thickness | | |
| | | | | | (nm) | | |
| | | | | | by first | | |
| | | | | | charging | | |
| | | | | | step | | |
| | | Charging rate | | | (percentage | | Discharge |
| | | [C] | | Function | to | | capacity |
| | Functional | First | Second | layer | functional | Confining | retention |
| | layer | charging | charging | thickness | layer | pressure | rate |
| | material | step | step | (nm) | thickness) | (MPa) | (%) |
| Example | LiCl | 0.01 | 0.05 | 250 | 250 | 3 | 100 |
| 1 | | | | | (100%) | | |
| Example | LiCl | 0.01 | 0.05 | 250 | 250 | 0 | 95 |
| 2 | | | | | (100%) | | |
| Example | LiCl | 0.01 | 0.05 | 250 | 250 | 0.1 | 96 |
| 3 | | | | | (100%) | | |
| Example | LiCl | 0.01 | 0.05 | 5000 | 5000 | 3 | 99 |
| 4 | | | | | (100%) | | |
| Example | LiCl | 0.01 | 0.05 | 250 | 500 | 3 | 100 |
| 5 | | | | | (200%) | | |
| Example | LiF | 0.01 | 0.05 | 250 | 250 | 3 | 100 |
| 6 | | | | | (100%) | | |
| Example | LiCl | 0.03 | 0.05 | 250 | 250 | 3 | 99 |
| 7 | | | | | (100%) | | |
| Example | Li₂O | 0.01 | 0.05 | 0.3 | 0.3 | 3 | 96 |
| 8 | | | | | (100%) | | |
| Example | LiCl | 0.01 | 0.05 | 25000 | 25000 | 3 | 97 |
| 9 | | | | | (100%) | | |
| Comparative | LiCl | 0.01 | 0.05 | 250 | 125 | 3 | 88 |
| Example | | | | | (50%) | | |
| 1 | | | | | | | |
| Comparative | LiCl | — | 0.05 | 250 | — | 3 | 83 |
| Example | | | | | | | |
| 2 | | | | | | | |
| Comparative | — | 0.01 | 0.05 | 0 | 250 | 3 | 82 |
| Example | | | | | | | |
| 3 | | | | | | | |

From the results listed in Table 1, it is found that the discharge capacity was improved in the lithium secondary battery manufactured by the method for manufacturing according to one or more embodiments of the present invention. In addition, in Example in which lithium metal was deposited to a thickness equivalent to the thickness of the functional layer in the first charging step, the manufacturing time of the lithium secondary battery was able to be shortened as compared with Example 5 in which lithium metal was deposited to a thickness twice the thickness of the functional layer.

### REFERENCE SIGNS LIST

10a Laminate type battery
11′ Negative electrode current collector
11″ Positive electrode current collector
12 Functional layer
13 Negative electrode active material layer
15 Positive electrode active material layer
17 Solid electrolyte layer
19 Single battery layer
21 Power generating element
25 Negative electrode current collecting plate
27 Positive electrode current collecting plate
29 Laminate film
100 Power generating element including pressurizing member
200 Metal plate
300 Bolt
400 Nut

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A method for producing a lithium secondary battery, the lithium secondary battery comprising:
a positive electrode;
a negative electrode;
a solid electrolyte layer interposed between the positive electrode and the negative electrode; and
a functional layer interposed between the solid electrolyte layer and the negative electrode, having an electron insulating property and lithium-ion conductivity, where the functional layer is more stable than the solid electrolyte layer in reductive decomposition, wherein:
the method comprises:
performing a first charging step on an uncharged lithium secondary battery from uncharged state until a thickness of lithium metal deposited by the first charging step becomes 90% or more of a thickness of the functional layer, thereby forming a lithium secondary battery precursor; and
performing a second charging step on the lithium secondary battery precursor, thereby forming the lithium secondary battery, wherein:
C₁<C₂ is satisfied when a maximum value of a first charging rate is C₁ and a minimum value of a second charging rate is C₂.

2. The method for producing the lithium secondary battery according to claim 1, wherein:
the first charging step is performed while the uncharged lithium secondary battery is pressurized at a pressure of 0.1 MPa or more in a lamination direction; and
the second charging step is performed while the lithium secondary battery precursor is pressurized at a pressure of 0.1 MPa or more in the lamination direction.

3. The method for producing the lithium secondary battery according to claim 1, wherein:
the first charging step is performed while the uncharged lithium secondary battery is pressurized at a pressure of 0.5 MPa or more and 5 MPa or less in a lamination direction; and
the second charging step is performed while the lithium secondary battery precursor is pressurized at a pressure of 0.5 MPa or more and 5 MPa or less in the lamination direction.

4. The method for producing the lithium secondary battery according to claim 1, wherein the maximum value C₁ of the first charging rate is 0.03 C or less.

5. The method for producing the lithium secondary battery according to claim 1, wherein the maximum value C₁ of the first charging rate is 0.01 C or less.

6. The method for producing the lithium secondary battery according to claim 1, wherein the thickness of the lithium metal deposited in the first charging step is substantially same as the thickness of the functional layer.

7. The method for producing the lithium secondary battery according to claim 1, wherein an average thickness of the functional layer is 0.5 nm to 20.0 μm.

8. The method for producing the lithium secondary battery according to claim 1, wherein the functional layer comprises one or more selected from the group consisting of lithium oxide (Li₂O), lithium chloride (LiCl), lithium fluoride (LiF), lithium bromide (LiBr), and lithium iodide (LiI).

9. The method for producing the lithium secondary battery according to claim 1, comprising an initial charging consisting of the first charging step and the second charging step, wherein:
the first charging step is performed until the thickness of the lithium metal deposited becomes 95% or more and 105% or less with respect to the thickness of the functional layer;
the first charging rate in the first charging step is constant; and
the second charging rate in the second charging step is constant.

10. The method for producing the lithium secondary battery according to claim 1, further comprising discharging the lithium secondary battery subjected to the second charging step, thereby forming the lithium secondary battery,
wherein a thickness of the lithium metal after the discharging is not thinner than the thickness of the lithium metal deposited in the first charging step.

11. The method for producing the lithium secondary battery according to claim 9, wherein the first charging step is performed until the thickness of the lithium metal deposited becomes the same thickness of the functional layer.
